(19) United States
(12) Patent Application Publication
(10) Pub. No.: US 2026/0179549 A1
(43) Pub. Date: Jun. 25, 2026

(54) SENSING CIRCUIT, DISPLAY DEVICE INCLUDING THE SAME, AND OPERATING METHOD OF THE SENSING CIRCUIT

(71) Applicant: SAMSUNG ELECTRONICS CO., LTD., Suwon-si (KR)

(72) Inventor: Hajun LEE, Suwon-si (KR)

(73) Assignee: SAMSUNG ELECTRONICS CO., LTD., Suwon-si (KR)

(21) Appl. No.: 19/307,218

(22) Filed: Aug. 22, 2025

Related U.S. Application Data
(60) Provisional application No. 63/711,005, filed on Oct. 23, 2024.

(30) Foreign Application Priority Data
Dec. 24, 2024 (KR) 10-2024-0196215

(51) Int. Cl. G09G 3/3233

(52) U.S. Cl. CPC G09G 3/3233; G09G 2300/0819; G09G 2300/0842; G09G 2310/027; G09G 2310/0289; G09G 2310/08; G09G 2320/0693

(57) ABSTRACT

A sensing circuit includes a sample and hold circuit configured to sample and hold a difference between a first input and a second input, based on a sensing voltage being a first input and an initial reference voltage being a second input, and an amplifying circuit configured to amplify and output an output of the sample and hold circuit, wherein the sample and hold circuit includes a first sampling capacitor configured to sample a voltage level of the sensing voltage, a second sampling capacitor configured to sample a voltage level of the initial reference voltage, and a first voltage switch circuit configured to set a voltage applied to one end of the first sampling capacitor and one end of the second sampling capacitor to a first level, which is the voltage level of the initial reference voltage.

### CROSS-REFERENCE TO RELATED APPLICATION

This application is based on and claims priority under 35 U.S.C. § 119 to Korean Patent Application No. 10-2024-0196215, filed on Dec. 24, 2024, in the Korean Intellectual Property Office, the disclosure of which is incorporated by reference herein in its entirety.

### BACKGROUND

The present disclosure relates to a sensing circuit, a display device including the same, and an operating method of the sensing circuit, and more particularly, the to a sensing circuit capable of operating by limiting an operating voltage of a sampling capacitor included in the sensing circuit within a certain range regardless of the absolute value of voltage connected to the sensing circuit, and the display device including the sensing circuit.

A display device includes a display panel for displaying images and a driving circuit for driving the display panel. The driving circuit may include a plurality of data drivers that apply voltage signals to data lines of the display panel and a plurality of gate drivers that activate gate lines of the display panel. The driving circuit may be provided in the form of an integrated circuit (IC) chip. In the display panel, a relatively high voltage is used, while a relatively low voltage is used in the driving circuit. Recently, to ensure the reliability of the display panel, it has become necessary to sense the voltage used in the display panel, and accordingly, the driving circuit is being implemented to include the sensing circuit.

### SUMMARY

Provided is a sensing circuit having a structure capable of reducing an area of a sampling capacitor included in the sensing circuit.

According to an aspect of the disclosure, a sensing circuit includes: a sample and hold circuit configured to sample and hold a voltage difference between a first input and a second input, based on a sensing voltage being the first input and an initial reference voltage being the second input; and an amplifying circuit configured to amplify and output an output of the sample and hold circuit, wherein the sample and hold circuit includes: a first sampling capacitor configured to sample a voltage level of the sensing voltage; a second sampling capacitor configured to sample the voltage level of the initial reference voltage; and a first voltage switch circuit configured to set a voltage applied to a first end of the first sampling capacitor and a first end of the second sampling capacitor to a first level, wherein the first level is the voltage level of the initial reference voltage.

According to an aspect of the disclosure, a sensing circuit configured to sense information received from a display panel and generate sensing data corresponding thereto, includes: a sample and hold circuit including a sampling capacitor, the sample and hold circuit being configured to: generate a first voltage difference between a sensing voltage and an initial reference voltage by sampling the sensing voltage and the initial reference voltage, and maintain the first voltage difference as a constant; and an amplifying circuit configured to amplify the first voltage difference to generate an output voltage, wherein the sampling capacitor includes: a first sampling capacitor configured to sample the sensing voltage; and a second sampling capacitor configured to sample the initial reference voltage, and wherein a range of an operating voltage of the first sampling capacitor is equal to or less than a second voltage difference between a first voltage level corresponding to the sensing voltage and a second voltage level corresponding to the initial reference voltage.

According to an aspect of the disclosure, a display device includes: a display panel including a plurality of organic light-emitting diodes (OLEDs) and a plurality of driving thin-film transistors (TFTs) configured to control an amount of light emitted from the OLEDs, wherein a plurality of pixels connected to data lines and sensing lines are arranged on the display panel; and a data driving circuit including: a plurality of digital-to-analog converters (DACs) configured to apply sensing data voltages to the data lines during a sensing operation, a plurality of sensing circuits configured to sense current information of the plurality of pixels through a plurality of sensing channels connected to the sensing lines, and a plurality of analog-to-digital converters (ADCs), each commonly connected to the plurality of sensing circuits, wherein each sensing circuit of the plurality of sensing circuits includes: a sample and hold circuit configured to generate and maintain constant a voltage difference between a first input and a second input, based on a sensing voltage being the first input and an initial reference voltage being the second input, and an amplifying circuit configured to amplify an output of the sample and hold circuit, and wherein the sample and hold circuit includes: a first sampling capacitor configured to sample a voltage level of the sensing voltage, a second sampling capacitor configured to sample the voltage level of the initial reference voltage, and a first voltage switch circuit configured to set a voltage applied to a first end of the first sampling capacitor and a first end of the second sampling capacitor to a first level, wherein the first level is the voltage level of the initial reference voltage.

According to an aspect of the disclosure, an operating method of a sensing circuit, includes: turning on a plurality of first switches to sample a first voltage corresponding to a first input to a first sampling capacitor and sample a second voltage corresponding to a second input to a second sampling capacitor; turning off the plurality of first switches and turning on a plurality of second switches to shift voltage levels of the first sampling capacitor and the second sampling capacitor; and turning off the plurality of second switches and turning on a plurality of third switches to transmit, to an amplifying circuit, a voltage difference between voltages stored in the first sampling capacitor and the second sampling capacitor, wherein the plurality of first switches includes a first voltage-setting switch and a second voltage-setting switch configured to set the voltage applied to one end of the first sampling capacitor and one end of the second sampling capacitor to a first level, wherein the first level corresponds to an initial reference voltage signal, and wherein the plurality of second switches includes a third voltage-setting switch and a fourth voltage-setting switch respectively configured to set one end of the first sampling capacitor and one end of the second sampling capacitor to a second level lower than the first level.

### BRIEF DESCRIPTION OF THE DRAWINGS

The above and/or other aspects will be more clearly understood from the following detailed description taken in conjunction with the accompanying drawings, in which:

FIG. 1 is a schematic block diagram of a display device according to an embodiment;

FIG. 2 is a schematic block diagram of a display device that implements compensation based on a current sensing method;

FIG. 3 is a circuit diagram for illustrating a connection structure between a pixel and a data driver integrated circuit (IC) applied to compensation of a current sensing method;

FIG. 4 is a diagram illustrating a configuration of a sensing circuit according to an embodiment;

FIG. 5 shows a timing diagram of signals for driving the sensing circuit illustrated in FIG. 4;

FIG. 6 is a diagram illustrating a configuration of a sensing circuit according to an embodiment;

FIG. 7 shows a timing diagram of signals for driving the sensing circuit illustrated in FIG. 6;

FIG. 8A illustrates a sensing circuit according to a comparative example, and FIG. 8B illustrates a timing diagram for driving the sensing circuit in FIG. 8A; and

FIG. 9 is a flowchart illustrating an operating method of a sensing circuit according to an embodiment for the sensing circuit.

### DETAILED DESCRIPTION

Hereinafter, various embodiments of the disclosure are described with reference to the attached drawings.

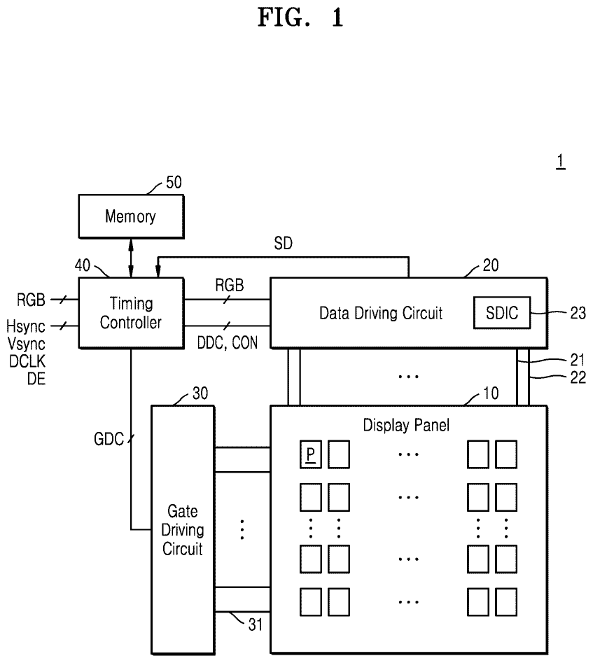

FIG. 1 is a schematic block diagram of a display device 1 according to an embodiment.

Referring to FIG. 1, the display device 1 according to an embodiment may include a display panel 10, a data driving circuit 20, a gate-driving circuit 30, a timing controller 40, and a memory 50.

In the display panel 10, a plurality of data lines 21 and sensing lines 22 intersect with a plurality of gate lines 31, and a pixel P may be arranged at each intersection in a matrix form. Each pixel P may be connected to any one of the data lines 21, any one of the sensing lines 22, and any one of the gate lines 31. Each pixel P is electrically connected to the data line 21 in response to a gate pulse input through the gate line 31, receives a data voltage from the data line 21, and may output a sensing signal through the sensing line 22. Each of the pixels P may receive a high potential driving voltage EVDD and a low potential driving voltage EVSS from a power generation unit, which is not shown. The pixel P according to the present embodiment may include an organic light-emitting diode (OLED), a driving transistor T_DRV, first and second switching transistors T_SW1 and T_SW2, and a storage capacitor C_ST for emission and compensation. The transistors constituting the pixel P may be implemented as either p-type or n-type. Additionally, the semiconductor layer of the transistors included in the pixel P may include amorphous silicon, polysilicon, or oxide material.

Each pixel P may operate differently during a display operation for image display and a sensing operation for obtaining a sensing value. The sensing operation may be performed for a predetermined period prior to the display operation or during vertical blanking periods within the display operation. The display operation may be performed as an operation by the data driving circuit 20 and the gate-driving circuit 30 under the control by the timing controller 40. The sensing operation may be performed as a different operation by the data driving circuit 20 and the gate-driving circuit 30 under the control by the timing controller 40. An operation of deriving compensation data for deviation compensation based on sensing results and a modulating operation for digital video data using the compensation data may be performed by the timing controller 40.

The data driving circuit 20 may include at least one data driver IC 23. The data driver IC 23 may include a plurality of digital-to-analog converters (DACs) connected to each data line 21, a plurality of sensing circuits connected to the sensing lines 22 through a plurality of sensing channels, and an analog-to-digital converter (ADC) commonly connected to the sensing circuits. During the display operation, the DAC of the data driver IC 23 may convert the digital video data RGB into the display data voltage for the image display according to a data timing control signal DDC applied by the timing controller 40 and supply the display data voltage to the data lines 21. During the sensing operation, the DAC of the data driver IC 23 may generate a sensing data voltage according to the data timing control signal DDC applied from the timing controller 40 and supply the sensing data voltage to the data lines 21. The ADC of the data driver IC 23 may sequentially digitally process the output of the sensing circuit and transmit the output to the timing controller 40.

During the display operation, the gate-driving circuit 30 may generate gate pulses for the image display based on a gate control signal GDC and then sequentially supply the gate pulses to the gate lines 31 in a row-sequential manner. The gate-driving circuit 30 may generate a sensing gate pulse based on the gate control signal GDC during the sensing operation and then sequentially supply the sensing gate pulse to the gate lines 31 in a row-sequential manner.

The timing controller 40, based on timing signals such as a vertical synchronization signal Vsync, a horizontal synchronization signal Hsync, a dot clock signal DCLK, and a data enable signal DE, may generate the data timing control signal DDC for controlling operation timing of the data driving circuit 20 and the gate control signal GDC for controlling the operation timing of the gate-driving circuit 30. The timing controller 40, based on a predetermined reference signal, such as a drive power enable signal, the vertical synchronization signal Vsync, or the data enable signal DE, may distinguish between the display operation and the sensing operation and generate the data timing control signal DDC and the gate control signal GDC according to each operation. The timing controller 40 may transmit digital data corresponding to the sensing data voltage to the data driving circuit 20 during the sensing operation. The timing controller 40 may apply a digital sensing value SD, transmitted from the data driving circuit 20 during the sensing operation to a pre-stored compensation algorithm, thereby storing compensation data that is capable of compensating for deviations in the memory 50. The timing controller 40, during the display operation, may modulate the digital video data RGB for image implementation by referring to the compensation data stored in the memory 50 and then transmit the modulated data to the data driving circuit 20.

According to the embodiment, during the compensating process of output data of the display panel 10 in this manner, the sensing circuit included in the data driver IC 23 of the data driving circuit 20 may include a sampling capacitor for sampling. In the present embodiment, the structure of the sensing circuit, which includes a sampling capacitor, allows a range of an operating voltage of the sampling capacitor to be limited to a certain voltage or lower. Accordingly, the sampling capacitor with a higher capacitance per unit area may be used, which may be effective in terms of chip size. In the present embodiment, a display panel is assumed and described, but embodiments of the disclosure are not limited thereto, and the disclosure may be applied to a panel including a touch sensor.

Hereinbelow, a display device capable of compensating output data of a display panel is described in more detail.

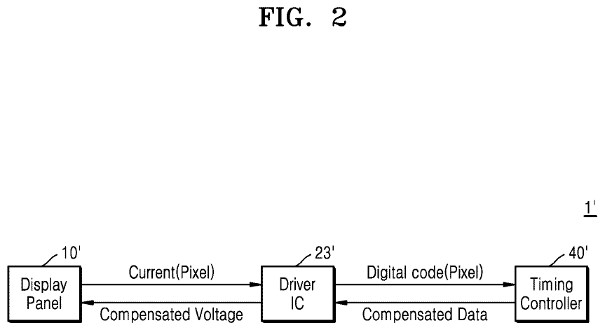

FIG. 2 is a schematic block diagram of a display device 1′ that implements compensation based on a current sensing method.

Referring to FIG. 2, the display device 1′ may include a display panel 10′, a data driver IC 23′, and a timing controller 40′. The display panel 10′ of FIG. 2 may correspond to the display panel 10 of FIG. 1, the data driver IC 23′ of FIG. 2 may correspond to the data driver IC 23 of FIG. 1, and the timing controller 40′ of FIG. 2 may correspond to the timing controller 40 of FIG. 1. FIG. 2 may be a diagram illustrating only some components of the display device 1 of FIG. 1 to explain the implementation of the compensation method for the display device.

The data driver IC 23′ may include a sensing circuit and sense current information input from the display panel 10′. The pixels of the display panel 10′ are connected to the sensing lines, and the sensing circuit may be connected to the sensing lines through the sensing channels. An input value (expressed as a voltage value) through the sensing line may be sampled/held and amplified and input to the ADC. The ADC may transmit a digital code, where an analog integration value has been converted into a digital sensing value, to the timing controller 40′. The timing controller 40′ derives the compensation data for compensating for threshold voltage deviation and mobility deviation based on the digital sensing value, and modulates image data for image implementation using this compensation data, and then transmits the modulated image data to the data driver IC 23′. The modulated image data may be converted into a display data voltage in the data driver IC 23′ and then applied to the display panel 10′.

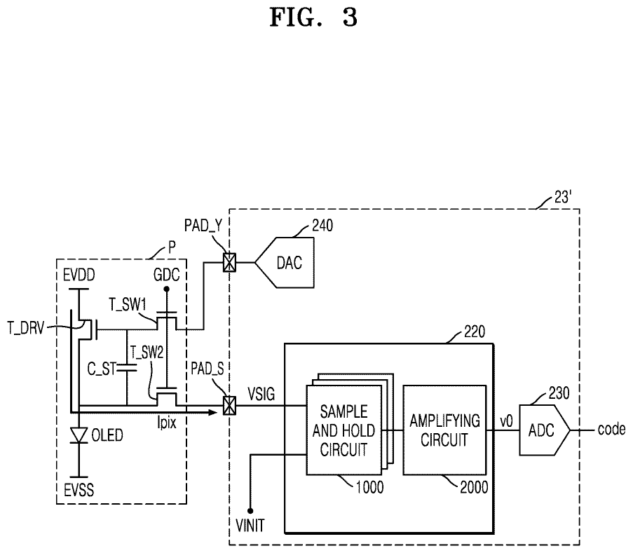

Below, referring to FIG. 3, relationships between the pixels P included in the display panel 10′ and components included in the data driver IC 23′ will be described in more detail.

FIG. 3 is a circuit diagram for illustrating a connection structure between a pixel and a data driver IC applied to the compensation mechanism of the current sensing method.

The pixel P of FIG. 3 may be included in the display panel 10 of FIG. 1. According to an embodiment, the pixel P may include the OLED, the driving transistor T_DRV the storage capacitor C_ST, the first switching transistor T_SW1 and the second switching transistor T_SW2. According to an embodiment, the pixel P may include a Quantum Dot (QD)-OLED.

The OLED may include an anode electrode connected to a driving transistor T_DRV, a cathode electrode connected to an input terminal of the low potential driving voltage EVSS, and an organic compound layer positioned between the anode electrode and the cathode electrode. The driving transistor T_DRV may be configured as a thin film transistor (TFT). The driving transistor T_DRV may control the amount of current input to the OLED depending on a gate-source voltage. The driving transistor T_DRV may include a gate electrode, a drain electrode connected to an input terminal of the high potential driving voltage EVDD, and a source electrode connected to the anode electrode of the OLED. A storage capacitor C_ST may be connected between a gate electrode and a source electrode of the driving transistor T_DRV. The first switching transistor T_SW1 may apply the data voltage input from the DAC 240 through a data pad PAD_Y to the gate electrode of the driving transistor T_DRV in response to the gate control signal GDC. The second switching transistor T_SW2 may switch a flow of current in the sensing line in response to the gate control signal GDC. While the first and second transistors T_SW1 and T_SW2 are turned on and a pixel current Ipix flows in the sensing line, the low potential driving voltage EVSS is applied below the threshold value so that the OLED may not affect the flow of the pixel current Ipix.

Referring to FIG. 3, the data driver IC 23′ may include an analog front-end circuit 220, an analog-to-digital converter 230, and a DAC 240. According to an embodiment, the analog front-end circuit 220 may be included in the sensing circuit of the present embodiment.

The pixel P may output the pixel current Ipix through the sensing line. According to an embodiment, the analog front-end circuit 220 may receive a sensing voltage VSIG that is a sensing target through a sensing pad PAD_S. The analog front-end circuit 220 may perform sampling operations, holding operations, and amplifying operations based on a plurality of sensing voltages VSIG to output an output voltage v0.

The analog front-end circuit 220 may be connected to an ADC 230 through a sample and hold circuit 1000 and an amplifying circuit 2000. The sample and hold circuit 1000 may include a plurality of sampling capacitors. The sample and hold circuit 1000 is configured in multiple stages and may receive signals corresponding to the plurality of sensing voltages VSIG and signals corresponding to a plurality of initial reference voltages VINIT. According to an embodiment, the sample and hold circuit 1000 may perform sampling and holding operations for the plurality of sensing voltages VSIG and initial reference voltages VINIT, and the amplifying circuit 2000 may perform voltage scaling and amplification for a voltage difference as a difference value between the plurality of sensing voltages VSIG and initial reference voltages VINIT, and output the output voltage v0. The amplifying circuit 2000 may include an amplifier and a feedback capacitor. The amplifier may sequentially receive and sequentially output the plurality of the sampled sensing voltages VSIG, and the feedback capacitor may be connected between an input terminal and an output terminal of the amplifier. The plurality of the sampled sensing voltages VSIG may be sequentially scaled by the amplifier and the feedback capacitor. According to an embodiment, the amplifying circuit 2000 may include a fully differential amplifier.

In an embodiment, the scaling operation may be a downscaling operation that reduces voltage levels thereof. For example, the plurality of the sensing voltages VSIG at high potential may be downscaled by a gain G to a plurality of result voltages at lower potential, where the gain G may be expressed as follows.

G=CS/CF [Equation 1]

Here, CS may be a capacitance of the sampling capacitor, and CF may be a capacitance of the feedback capacitor. To perform the downscaling operation, the capacitance of the feedback capacitor CF may be greater than the capacitance of the sampling capacitor CS.

The ADC 230 may perform an analog-to-digital conversion operation that converts the output voltage v0 into a digital signal.

Referring to FIGS. 1 to 3, in a process of externally compensating for data of the sensing voltages of the display panel according to the present embodiment, the sampling capacitor may be necessarily included, and the operating voltage of the sampling capacitor may cause an issue directly related to an occupied area of the sampling capacitor. According to an embodiment, the sampling capacitor may be implemented as a metal-insulator-metal (MIM) capacitor. The MIM capacitor may be implemented, not only for the sampling capacitor of the sensing circuit, but also for a capacitor included in the ADC 230. The sampling capacitor of the sensing circuit may be a capacitor that stores a relatively high voltage, and the capacitor in the ADC 230 may be a capacitor that stores a relatively low voltage. In the sampling capacitor storing high voltage in the sensing circuit, a thicker insulator is adopted due to high driving voltage, thus reducing the capacitance per unit area. Consequently, to achieve higher capacitance, the size of the capacitor may be increased. Since the sampling capacitor of the sensing circuit and the capacitor in the ADC 230 are implemented in the same metal layer region, when the sampling capacitor of the sensing circuit becomes larger, the size of the capacitor of the ADC 230 also increases, which increases the area of an entire system including both the capacitors, such that chip competitiveness may be reduced. To address this issue, the present embodiment proposes the structure of the sensing circuit capable of limiting the maximum operating voltage of the sampling capacitor, regardless of the voltages applied to the sensing circuit. Through the structure, the sensing circuit becomes capable of reducing the operating voltage of the sampling capacitor, allowing an increase in capacitance per unit area. As a result, the area of the metal layer region where the MIM is placed may be reduced, preventing the unnecessary expansion of the sampling capacitor's area and ultimately reducing the overall chip size. Below, a more detailed operation by the sensing circuit will be described with reference to the drawings.

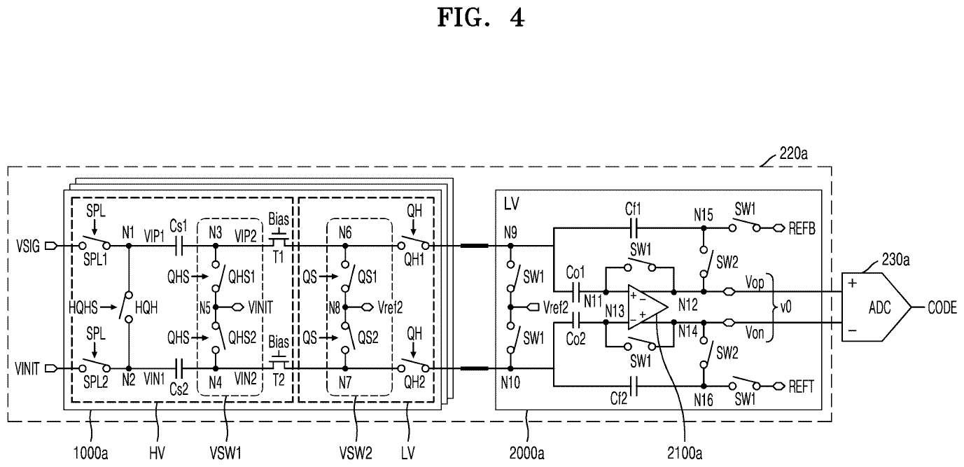

FIG. 4 is a diagram illustrating a configuration of a sensing circuit 220a according to an embodiment. Referring to FIG. 4, the sensing circuit 220a may include a sample and hold circuit 1000a and an amplifying circuit 2000a, and an output of the sensing circuit 220a may be connected to an ADC 230a.

The sample and hold circuit 1000a may include a high-voltage region HV and a low-voltage region LV. The high-voltage region HV may be a region where elements placed in that region are implemented to include high-voltage elements. According to an embodiment, since the sensing voltage VSIG and the initial reference voltage VINIT are relatively high voltages, circuit elements included in a circuit area that sampling the sensing voltage VSIG and the initial reference voltage VINIT may include high-voltage switching elements capable of withstanding high voltage, i.e., not being damaged by the high voltage. For example, the high-voltage switching element may include a high-voltage transistor having a relatively high threshold voltage. For example, the high-voltage switching element may include a high-voltage capacitor capable of withstanding the high voltage. The low-voltage region LV may be a region where circuit elements placed therein are implemented, including low-voltage elements. The low-voltage region LV may be a circuit area that operates using relatively low voltage and may include a low-voltage switching element. For example, the low-voltage switching element may include a low-voltage transistor having a relatively low threshold voltage and a low-voltage capacitor.

Referring to FIG. 4, the high-voltage region HV of the sample and hold circuit 1000a includes a first sampling switch SPL1 and a second sampling switch SPL2, each configured to sample a corresponding voltage level of the sensing voltage VSIG and the initial reference voltage VINIT in FIG. 3, a first sampling capacitor Cs1 configured to store the sensing voltage VSIG applied through the first sampling switch SPL1, a second sampling capacitor Cs2 configured to store the initial reference voltage VINIT applied through the second sampling switch SPL2, a connection switch HQH electrically connected between a first node N1 disposed between the first sampling switch SPL1 and the first sampling capacitor Cs1, and a second node N2 disposed between the second sampling switch SPL2 and the second sampling capacitor Cs2, a first bias transistor T1 and a second bias transistor T2, each configured to control a corresponding signal transmission from the high-voltage region HV to the low-voltage region LV, and a first voltage switch circuit VSW1 electrically connected between a third node N3 disposed between the first sampling capacitor Cs1 and the first bias transistor T1, and a fourth node N4 disposed between the second sampling capacitor Cs2 and the second bias transistor T2.

The low-voltage region LV of the sample and hold circuit 1000a may include a first holding switch QH1 and a second holding switch QH2 for transmitting the sensing voltage VSIG stored in the first sampling capacitor Cs1 and the initial reference voltage VINIT stored in the second sampling capacitor Cs2 to the amplifying circuit 2000a, and a second voltage switch circuit VSW2 for applying a second reference voltage Vref2 to one end of each of the first sampling capacitor Cs1 and the second sampling capacitor Cs2 during sampling processes.

The sample and hold circuit 1000a may receive a signal corresponding to the sensing voltage VSIG and a signal corresponding to the initial reference voltage VINIT. The sensing voltage VSIG may be a sensing voltage corresponding to a current value received from a pixel included in the display panel, and the initial reference voltage VINIT may be a reference voltage applied to implement a differential manner. According to an embodiment, the voltage level of the initial reference voltage VINIT may range from 2 V to 7 V. According to an embodiment, the sensing voltage VSIG may not differ by more than about 4 V from the initial reference voltage VINIT. In an embodiment, the maximum voltage difference between the voltage level of the sensing voltage VSIG and the voltage level of the initial reference voltage VINIT may be about 4 V.

One end of the first sampling switch SPL1 may be connected to an end receiving the signal corresponding to the sensing voltage VSIG. One end of the second sampling switch SPL2 may be connected to an end receiving the signal corresponding to the initial reference voltage VINIT. The first sampling switch SPL1 and the second sampling switch SPL2 may be turned on and operated by a sampling signal SPL. The first sampling capacitor Cs1 may be connected to the other end of the first sampling switch SPL1. The first sampling capacitor Cs1 may store the sensing voltage VSIG according to the turn-on of the first sampling switch SPL1. The second sampling capacitor Cs2 may be connected to the other end of the second sampling switch SPL2. The second sampling capacitor Cs2 may store the initial reference voltage VINIT according to the turn-on of the second sampling switch SPL2.

One end of the connection switch HQH may be connected to the first node N1 between the first sampling capacitor Cs1 and the first sampling switch SPL1. The other end of the connection switch HQH may be connected to the second node N2 between the second sampling capacitor Cs2) and the second sampling switch SPL2. The connection switch HQH may be turned on and operated by a connection signal HQHS.

The first bias transistor T1 may be connected to the other end of the first sampling capacitor Cs1. The second bias transistor T2 may be connected to the other end of the second sampling capacitor Cs2. A bias signal Bias may be input to gates of the first bias transistor T1 and the second bias transistor T2. As the bias signal Bias is input, the third node N3 and a sixth node N6 may be electrically connected, and the fourth node N4 and a seventh node N7 may be electrically connected. An electrical connection between the high-voltage region HV and the low-voltage region LV may be determined through the first bias transistor T1 and the second bias transistor T2.

The first voltage switch circuit VSW1 may be connected to the third node N3 between the first sampling capacitor Cs1 and the first bias transistor T1, and the fourth node N4 between the second sampling capacitor Cs2 and the second bias transistor T2. The first voltage switch circuit VSW1 may set one end of the first sampling capacitor Cs1 and the second sampling capacitor Cs2 to the voltage level of the initial reference voltage VINIT. The first voltage switch circuit VSW1 may include a first voltage-setting switch QHS1 and a second voltage-setting switch QHS2. One end of the first voltage-setting switch QHS1 may be connected to the third node N3. One end of the second voltage-setting switch QHS2 may be connected to the fourth node N4. The other ends of the first voltage-setting switch QHS1 and the second voltage-setting switch QHS2 share a fifth node N5 and may be connected to each other. A terminal capable of applying the voltage level of the initial reference voltage VINIT may be connected to the fifth node N5. The first voltage-setting switch QHS1 and the second voltage-setting switch QHS2 may be turned on and operated by a first voltage-setting signal QHS. By turning on the first voltage-setting switch QHS1 and the second voltage-setting switch QHS2, a voltage applied to one end of the first sampling capacitor Cs1 and the second sampling capacitor Cs2 may be set to the initial reference voltage VINIT.

One end of the first holding switch QH1 may be connected to the other end of the first bias transistor T1. One end of the second holding switch QH2 may be connected to the other end of the second bias transistor T2. The first holding switch QH1 and the second holding switch QH2 may be turned on and operated by a holding signal QH.

The second voltage switch circuit VSW2 may be connected to the sixth node N6 between the first bias transistor T1 and the first holding switch QH1, and the seventh node N7 between the second bias transistor T2 and the second holding switch QH2. The second voltage switch circuit VSW2 may set one end of the first sampling capacitor Cs1 and the second sampling capacitor Cs2 to a voltage level of the second reference voltage Vref2. The voltage level of the second reference voltage Vref2 may be lower than the voltage level of the initial reference voltage VINIT. The second voltage switch circuit VSW2 may include a third voltage-setting switch QS1 and a fourth voltage-setting switch QS2. One end of the third voltage-setting switch QS1 may be connected to the sixth node N6. One end of the fourth voltage-setting switch QS2 may be connected to the seventh node N7. The other ends of the third voltage-setting switch QS1 and the fourth voltage-setting switch QS2 share an eighth node N8 and may be connected to each other. A terminal capable of applying the voltage level of the second reference voltage Vref2 may be connected to the eighth node N8. The third voltage-setting switch QS1 and the fourth voltage-setting switch QS2 may be turned on and operated by the second voltage-setting signal QS. By turning on the third voltage-setting switch QS1 and the fourth voltage-setting switch QS2, the voltage applied to one end of the first sampling capacitor Cs1 and the second sampling capacitor Cs2 may be set to the second reference voltage Vref2. The second voltage switch circuit VSW2 may be a circuit for level-shifting the voltages of the sixth node N6 and the seventh node N7 to low voltages.

The amplifying circuit 2000a may generate the output voltage v0 as an output by scaling and amplifying a voltage difference between the voltages stored in the first sampling capacitor Cs1 and the second sampling capacitor Cs2 in the amplification period. The amplifying circuit 2000a may include a plurality of first switches SW1, a plurality of second switches SW2, a first offset capacitor Co1, a second offset capacitor Co2, a first feedback capacitor Cf1, a second feedback capacitor Cf2, and an amplifier 2100a. According to an embodiment, circuit elements included in the amplifying circuit 2000a may be low-voltage elements.

The amplifying circuit 2000a may include two of the first switches SW1 connected in series between a ninth node N9 and a tenth node N10, and the second reference voltage Vref2 may be connected to a node between two of the first switches SW1. The amplifying circuit 2000a may include one of the first switches SW1 connected between an 11th node N11 and a 12th node N12, a second one of the plurality of first switches SW1 connected between a 13th node N13 and a 14th node N14, a third one of the plurality of first switches SW1 connected between a first driving voltage REFB and a 15th node N15, a fourth one of the plurality of first switches SW1 connected between a second driving voltage REFT and a 16th node N16, one of the plurality of second switches SW2 connected between the 12th node N12 and the 15th node N15, a second one of the plurality of second switches SW2 connected between the 14th node N14 and the 16th node N16, a first feedback capacitor Cf1 connected between the 9th node N9 and the 15th node N15, a second feedback capacitor Cf2 connected between the 10th node N10 and the 16th node N16, a first offset capacitor Co1 connected between the 9th node N9 and the 11th node N11, a second offset capacitor Co2 connected between the 10th node N10 and the 13th node N13, and an amplifier 2100a. The amplifier 2100a may include a non-inverting input terminal connected to the 11th node N11, an inverting input terminal connected to the 13th node N13, a non-inverting output terminal connected to the 14th node N14, and an inverting output terminal connected to the 12th node N12. The amplifier 2100a may generate a first amplifier output voltage Vop and apply the same to the 12th node N12. The amplifier 2100a may generate a second amplifier output voltage Von and apply the same to the 14th node N14. That is, the amplifier 2100a may generate the output voltage v0 corresponding to a voltage difference between the first amplifier output voltage Vop and the second amplifier output voltage Von. The amplifier 2100a may be implemented as an operational amplifier (OP Amp). According to an embodiment, the plurality of the first switches SW1 may be turned on and operated according to a first switch signal SW1_S, and the plurality of the second switches SW2 may be turned on and operated according to a second switch signal SW2_S.

The ADC 230a may convert the output voltage v0 of the sensing circuit 220a into a digital code CODE. In an embodiment, the ADC 230a may be implemented in the differential manner.

The final output voltage v0 may be obtained according to the following equation.

$$v 0 = {V}_{op} - {V}_{o n} = \frac{{C}_{s}}{{C}_{f}} ( VSIG - VINIT ) - ( REFT - REFB )$$

In the formula, Vop may represent the first amplifier output voltage, Von may represent the second amplifier output voltage, Cf may represent the capacitance of the first feedback capacitor Cf1 and the second feedback capacitor Cf2, Cs may represent the capacitance of the first sampling capacitor Cs1 and the second sampling capacitor Cs2, VSIG may represent the voltage level of the sensing voltage, VINIT may represent the voltage level of the initial reference voltage, REFT may represent the voltage level of the second driving voltage, and REFB may represent the voltage level of the first driving voltage.

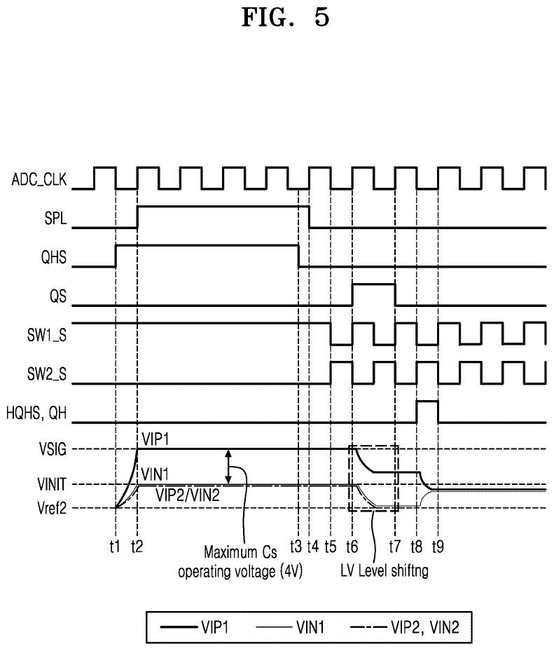

FIG. 5 shows a timing diagram of signals for driving the sensing circuit 220a illustrated in FIG. 4.

In the timing diagram of FIG. 5, all signals ADC_CLK, SPL, QHS, QS, SW1, SW2, HQHS and QHS may include an activation section with a high level and a deactivation section with a low level. Each switch, which operates in response to each signal, may be turned on in the activation section to connect both ends of the switch, and may be turned off in the deactivation section to disconnect both ends of the switch. Referring to the timing diagram of FIG. 5, changes in levels of a voltage VIP1 at one end of the first sampling capacitor CS1, a voltage VIP2 at the other end of the first sampling capacitor CS1, a voltage VIN1 at one end of the second sampling capacitor CS2, and a voltage VIN2 at the other end of the second sampling capacitor CS2, corresponding to the operation of each signal, are shown together. According to an embodiment, the voltage level of VIP1 at one end of the first sampling capacitor Cs1 may correspond to a voltage level of the first node N1, the voltage level of VIP2 at the other end of the first sampling capacitor Cs1 may correspond to a voltage level of the third node N3, the voltage level of VIN1 at one end of the second sampling capacitor Cs2 may correspond to a voltage level of the second node N2, and the voltage level of VIN2 at the other end of the second sampling capacitor Cs2 may correspond to a voltage level of the fourth node N4.

As illustrated in FIG. 5, the clock signal ADC_CLK may be toggled regularly so that the activation section and deactivation section are repeated in the same cycle. According to an embodiment, a plurality of signals SPL, QHS, QS, SW1, SW2, HQHS and QHS may operate based on the clock signal ADC_CLK as a reference signal.

At a first time point t1, the first voltage-setting signal QHS may transition from a first level to a second level. According to an embodiment, the first level may be the low level and the second level may be the high level. By turning on the first voltage-setting signal QHS at the first time point t1, the third node N3 and the fourth node N4 may be electrically connected together, and the voltage level of one end of the first sampling capacitor Cs1 and the second sampling capacitor Cs2 may be set to be equal to the voltage level corresponding to the initial reference voltage VINIT. According to an embodiment, by turning on the first voltage-setting signal QHS, the voltage levels of the third node N3, which is one end of the first sampling capacitor Cs1, and the fourth node N4, which is one end of the second sampling capacitor Cs2, may be set to and maintained at the level of the initial reference voltage VINIT.

At the second time point t2, the sampling signal SPL may transition from the first level to the second level. At the second time point t2, by turning on the sampling signal SPL, the first sampling capacitor Cs1 may be charged with a voltage corresponding to the sensing voltage VSIG, and the second sampling capacitor Cs2 may be charged with a voltage corresponding to the initial reference voltage VINIT. Accordingly, the level of VIP1, which is a voltage applied to the first node N1, which is the other end of the first sampling capacitor Cs1, may become equal to the voltage level of the sensing voltage VSIG, and the level of VIN1, which is a voltage applied to the second node N2, which is the other end of the second sampling capacitor Cs2, may become equal to the voltage level of the initial reference voltage VINIT. At this time, the operating voltage for operating the first sampling capacitor Cs1 corresponds to a voltage difference between the first node N1 and the third node N3, so the maximum operating voltage of the first sampling capacitor Cs1 may be the voltage difference between the voltage level of VSIG and that of VINIT. That is, by maintaining the voltage VIN1 of the second node N2, the voltage VIP2 of the third node N3, and the voltage VIN2 of the fourth node N4, excluding the voltage VIP1 of the first node N1, at a certain interval at the level of the initial reference voltage VINIT by the first voltage switch circuit VSW1, even if the absolute values of the initial reference voltage VINIT and the sensing voltage VSIG are large, only the voltage difference between the initial reference voltage VINIT and the sensing voltage VSIG is used as the operating voltage to drive the first sampling capacitor Cs1 so that the first sampling capacitor Cs1 only needs to occupy an area that may cover the operating voltage corresponding to the voltage difference, and therefore, unnecessary increase in the area of the sampling capacitor may be minimized. According to an embodiment, the first voltage switch circuit VSW1 may set a lower reference of a range of the operating voltage of the first sampling capacitor Cs1 as the initial reference voltage VINIT.

During the second time point t2 to the third time point t3, the sampling signal SPL and the first voltage-setting signal QHS may be maintained at the second level. At this time, the operating voltage of the first sampling capacitor Cs1 may be limited to the voltage difference between the voltage level of VSIG and that of VINIT. According to an embodiment, since the voltage level of VSIG may not exceed about 4 V greater than the voltage level of VINIT, the maximum value of the operating voltage of the first sampling capacitor Cs1 may be about 4 V. Accordingly, the range of the operating voltage of the first sampling capacitor Cs1 according to the present embodiment may be a range equal to or smaller than the voltage difference between the voltage level of VSIG corresponding to the sensing voltage and the voltage level of VINIT corresponding to the initial reference voltage.

At the third time point t3, the first voltage-setting signal QHS may transition from the second level to the first level. At the fourth time point t4, the sampling signal SPL may transition from the second level to the first level. Accordingly, a voltage corresponding to the sensing voltage VSIG and a voltage corresponding to the initial reference voltage VINIT may be stored and maintained in the first sampling capacitor Cs1 and the second sampling capacitor Cs2, respectively.

At the fifth time point t5, the first switch signal SW1_S of the amplifying circuit 2000a may transition from the second level to the first level. At this time, the second switch signal SW2_S of the amplifying circuit 2000a may transition from the first level to the second level. The first switch signal SW1_S and the second switch signal SW2_S may be toggled by repeating the first level and the second level at regular intervals. According to an embodiment, the first switch signal SW1_S and the second switch signal SW2_S may be complementary to each other. When the first switch signal SW1_S maintains the first level, the second switch signal SW2_S may maintain the second level, and conversely, when the first switch signal SW1_S maintains the second level, the second switch signal SW2_S may maintain the first level. By the first switch signal SW1_S and the second switch signal SW2_S operating complementarily, the amplifying circuit 2000a may receive and amplify the output of the sample and hold circuit 1000a.

At the sixth time point t6, the second voltage-setting signal QS may transition from the first level to the second level. Accordingly, the third voltage-setting switch QS1 and the fourth voltage-setting switch QS2 may be turned on, and accordingly, the voltage levels of the sixth node N6 and the seventh node N7 may be set to the second reference voltage Vref2. The second reference voltage Vref2 may have a lower voltage level than the initial reference voltage VINIT. Accordingly, the voltage levels of VIN2, VIP2, and VIN1 may be level-shifted from the level of the initial reference voltage VINIT to correspond to the level of the second reference voltage Vref2, and the voltage level of VIP1 may be level-shifted while maintaining an interval, or in other words, the voltage difference between the voltage level of VSIG and that of VINIT. Although not shown in the timing diagram of FIG. 5, the bias signal Bias capable of driving the first bias transistor T1 and the second bias transistor T2 may be applied in response to the turn-on period of the second voltage-setting signal QS. By the second voltage switch circuit VSW2, the operating range of voltage at both ends of the first sampling capacitor Cs1 (i.e., the voltage difference between the voltages at both ends of the first sampling capacitor Cs1) may be maintained, while the voltage applied to one end of the first sampling capacitor Cs1 may be level-shifted to the value of the second reference voltage. At this time, since VIP1 and VIN1 are in a floating state, the charge of the first sampling capacitor Cs1 may be maintained.

At the seventh time point t7, the second voltage-setting signal QS may transition from the second level to the first level, and accordingly, the third voltage-setting switch QS1 and the fourth voltage-setting switch QS2 may be turned off. Accordingly, the level shifting is completed, and the voltage level of VIP1 and the voltage level of VIN1 may be maintained at a constant level. As a result, the voltage level across the sampling capacitors may be easily level-shifted from the high-voltage region to the low voltage region, and a stable operation of the sensing circuit may be achieved.

After that, at the 8th time point t8, the holding signal QH and the connection signal HQHS may transition from the first level to the second level. Accordingly, voltage values stored in the sampling capacitor of the sample and hold circuit 1000a may be transmitted to the amplifying circuit 2000a, and the amplifying circuit 2000a may amplify the corresponding values and output the same to the ADC 230a according to the turn-on of the second switch signal SW2_S.

According to the present embodiment, the operating voltage of the sampling capacitor may be maintained low regardless of the absolute values of the voltage levels of the initial reference voltage VINIT and the sensing voltage VSIG. According to the present embodiment, even if the initial reference voltage VINIT and the sensing voltage VSIG are used at high levels in various applications, the operating voltage across the sampling capacitor remains constant, allowing the capacitor size to be minimized and thereby enhancing area efficiency.

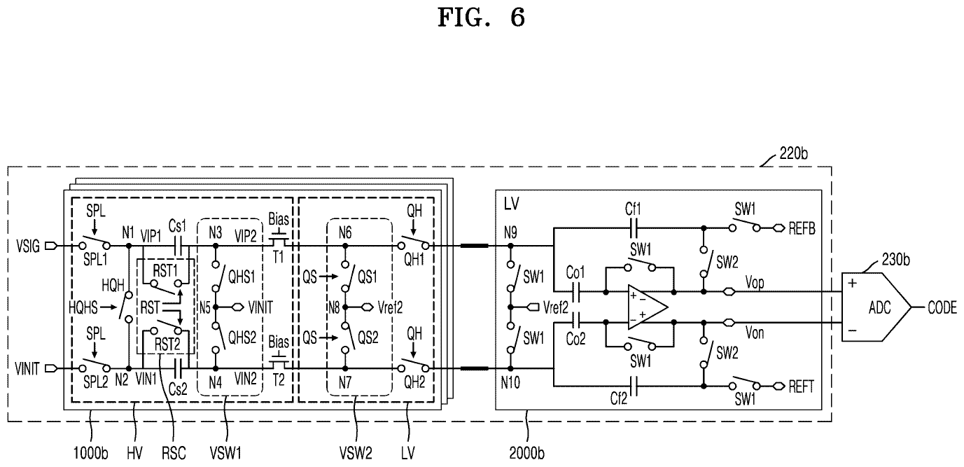

FIG. 6 is a diagram illustrating a configuration of a sensing circuit according to an embodiment. Referring to FIG. 6, a sensing circuit 220b may include a sample and hold circuit 1000b and an amplifying circuit 2000b, and outputs from the sensing circuit 220b may be transmitted to an ADC 230b.

Regarding the configuration of the sensing circuit 220b in FIG. 6, the explanation of circuit elements included in the sample and hold circuit 1000b and the amplifying circuit 2000b will be omitted for elements having the same reference numerals as those in the sample and hold circuit 1000a and the amplifying circuit 2000a of the sensing circuit 200a in FIG. 5, as they are redundant, and only the differences will be described.

The sample and hold circuit 1000b of FIG. 6 may further include a reset circuit RSC. The reset circuit RSC may include a first reset switch RST1 and a second reset switch RST2. The reset circuit RSC may be a circuit capable of resetting the operating voltage at both ends of the first sampling capacitor Cs1 and the second sampling capacitor Cs2. The first reset switch RST1 may be connected in parallel to the first sampling capacitor Cs1. The second reset switch RST2 may be connected in parallel to the second sampling capacitor Cs2. The first reset switch RST1 and the second reset switch RST2 may be turned on and operated by the reset signal RST.

The sensing circuit 220b according to the present embodiment, by including the reset circuit RSC, may minimize settling times for signals during the sampling operation and stably limit the maximum voltage of the first sampling capacitor Cs1 and the second sampling capacitor Cs2.

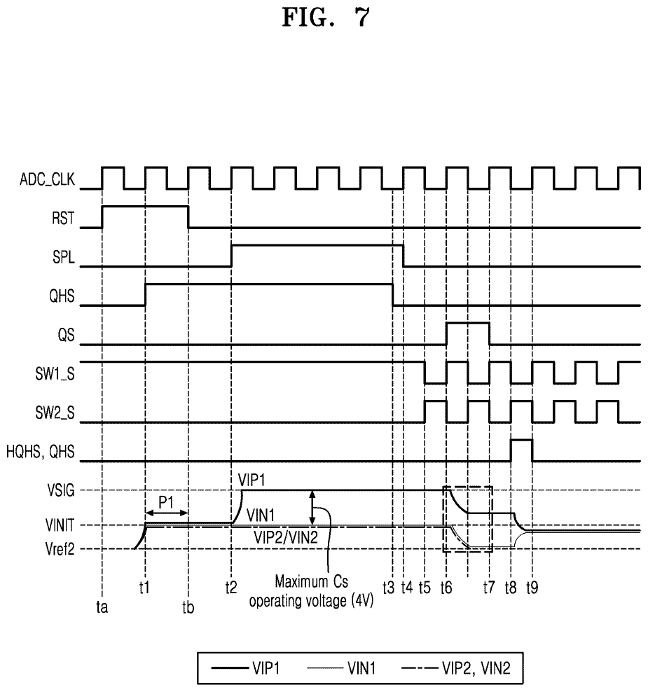

FIG. 7 shows a timing diagram of signals for driving the sensing circuit 220b illustrated in FIG. 6. In the description of the timing diagram in FIG. 7, any explanation overlapping with that in FIG. 5 will be omitted, and only the differing parts will be described.

Referring to FIG. 7, at a first reset point ta, the reset signal RST may transition from the first level to the second level. At a first time point t1, the first voltage-setting signal QHS may transition from the first level to the second level. At a second reset time point tb, the reset signal RST may transition from the second level to the first level.

Accordingly, a period P1 between the first time point t1 and the second reset time point tb may be a period in which the first reset switch RST1, the second reset switch RST2, the first voltage-setting switch QHS1, and the second voltage-setting switch QHS2 are all turned on. Accordingly, VIP1, which is the voltage level at the first node N1 of the first sampling capacitor Cs1, may maintain the level of the initial reference voltage VINIT from the first time point t1 to the second time point t2, which is the time point at which the sampling signal SPL transitions from the first level to the second level. Additionally, VIP2 with the voltage level of the third node N3 of the first sampling capacitor Cs1, VIN1 with the voltage level of the second node N2 of the second sampling capacitor Cs2, and VIN2 with the voltage level of the fourth node N4 of the second sampling capacitor Cs2 may also maintain the initial reference voltage VINIT. Such processes may continue until the second time point t2, at which the sampling signal SPL transitions from the first level to the second level.

VIP1, the voltage level at the first node N1 after the second time point t2, may be the same as the timing diagram described with reference to FIG. 5.

In this way, by turning on the reset signal RST in a period prior to starting sampling, the voltage at both ends of the sampling capacitor may be initialized to 0. Furthermore, by controlling the signals to provide a period in which both the reset signal RST and the first voltage-setting signal QHS are turned on, the voltage at both ends of the sampling capacitor may be set to the initial reference voltage VINIT. Through this, the signal settling time may be minimized during sampling, and the maximum voltage at both ends of the sampling capacitor may be stably limited. According to an embodiment, the turning on of the reset signal RST may be performed at any time before the sensing operation starts.

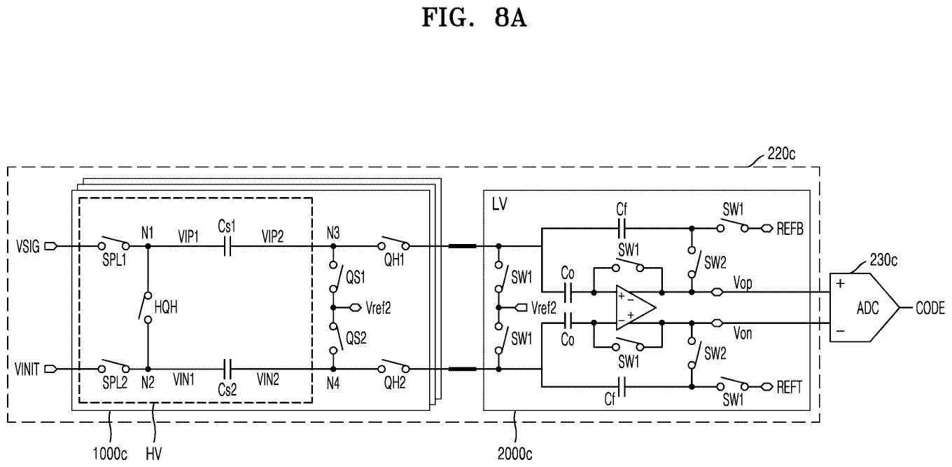

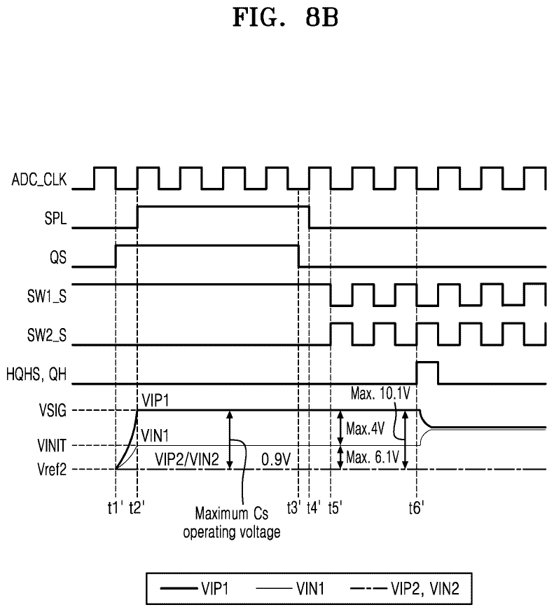

FIG. 8A illustrates a sensing circuit 220c according to a comparative example, and FIG. 8B illustrates a timing diagram for driving the sensing circuit 220c in FIG. 8A.

Referring to FIG. 8A, the sensing circuit 220c and an ADC 230c are shown, according to the comparative example. The sensing circuit 220c may include a sample and hold circuit 1000c and an amplifying circuit 2000c. The sample and hold circuit 1000c may include the first sampling switch SPL1, the second sampling switch SPL2, the first sampling capacitor Cs1, the second sampling capacitor Cs2, the third voltage-setting switch QS1, the fourth voltage-setting switch QS2, the first holding switch QH1, the second holding switch QH2, and the connection switch HQH. According to the comparative example, the first sampling switch SPL1 and the second sampling switch SPL2 may be turned on and operated by the sampling signal SPL. According to the comparative example, the third voltage-setting switch QS1 and the fourth voltage-setting switch QS2 may be turned on and operated by the second voltage-setting signal QS. According to the comparative example, the first holding switch QH1 and the second holding switch QH2 may be turned on and operated by a holding signal QH, and the connection switch HQH may be turned on and operated by a connection signal HQHS.

Referring to FIG. 8B, an operation timing diagram of signals applied to the sensing circuit 220c according to the comparative example is shown.

At a first time point t1′, the second voltage-setting signal QS applied to the third voltage-setting switch QS1 and the fourth voltage-setting switch QS2 may transition from the first level to the second level. Accordingly, one end of the first sampling capacitor Cs1 and the second sampling capacitor Cs2 may be set to the second reference voltage Vref2. QS again transitions at time point t3′ in FIG. 8B.

As the sampling signal SPL transitions from the first level to the second level at a second time point t2′, VIP1 with the voltage level at the first node N1 of the first sampling capacitor Cs1, may have a voltage level corresponding to the sensing voltage VSIG, and VIP2 with the voltage level at the third node N3 of the first sampling capacitor Cs1, may have the voltage level of the second reference voltage Vref2. As the sampling signal SPL transitions from the first level to the second level at the second time point t2′, the voltage level of VIN1 at the second node N2 of the second sampling capacitor Cs2 may have a voltage level corresponding to the initial reference voltage VINIT, and the voltage level of VIN2 at the fourth node N4 of the second sampling capacitor Cs2 may have the voltage level of the second reference voltage Vref2. In FIG. 8B, the sampling signal SPL again transitions at a time point t4′. The time point t5′ marks a transition of SW1_S as in FIG. 7. A transition of the holding signal QH is marked by time point t6′.

Accordingly, the range of the operating voltage of the first sampling capacitor Cs1 may correspond to the voltage difference (VSIG−Vref2) between the voltage level at the first node N1 and the voltage level at the third node N3. According to an embodiment, the sensing voltage VSIG and the initial reference voltage VINIT may be high voltages, and the second reference voltage Vref2 may be a low voltage. In an comparative example, the sensing voltage VSIG is assumed to be 11 V, the initial reference voltage VINIT is 7 V, and the second reference voltage Vref2 is 0.9 V. In this case, the operating voltage of the first sampling capacitor CS1 may be the voltage difference between the voltage level of the sensing voltage VSIG and the voltage level of the second reference voltage Vref2, which is 11V−0.9V=10.1V. Similarly, the operating voltage of the second sampling capacitor CS2 may be the voltage difference between the voltage level of the initial reference voltage VINIT and the voltage level of the second reference voltage Vref2, which is 7V−0.9V=6.1V.

That is, the operating voltage range of the first sampling capacitor Cs1 and the second sampling capacitor Cs2 according to the comparative example increases as the absolute value of the sensing voltage VSIG increases, and accordingly, the area of the sampling capacitor for covering the operating voltage increases, resulting in an issue in that the area of the entire system increases.

In contrast, in the present embodiment, since the range of the operating voltage of the first sampling capacitor Cs1 is limited to the voltage difference between the sensing voltage VSIG and the initial reference voltage VINIT regardless of the absolute value of the sensing voltage VSIG, the operating voltage of the sampling capacitor may be reduced, thereby effectively saving area. Assuming that the sensing voltage VSIG is 11 V, the initial reference voltage VINIT is 7 V, and the second reference voltage Vref2 is 0.9 V, the operating voltage of the first sampling capacitor Cs1 according to the present embodiment is the difference between the voltage level of the sensing voltage VSIG and the voltage level of the initial reference voltage VINIT so that 11 V−7 V=4 V, and thus the operating voltage is significantly lowered under the same conditions, which may be efficient in terms of area.

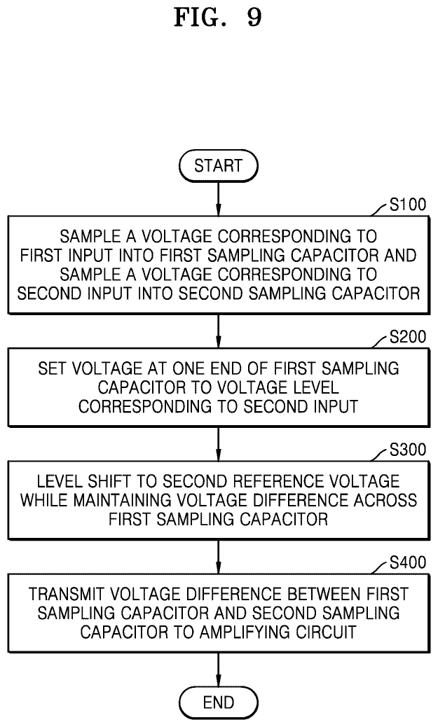

FIG. 9 is a flowchart illustrating an operating method of a sensing circuit according to an embodiment for the sensing circuit. The operating method of FIG. 9, according to an embodiment, may be the method of operating the sensing circuit 220a of FIG. 4 corresponding to another embodiment.

Referring to operation S100, the sample and hold circuit 1000a of the sensing circuit 220a may sample a voltage corresponding to a first input to the first sampling capacitor Cs1 and sample a voltage corresponding to a second input to second sampling capacitor Cs2. According to an embodiment, the voltage corresponding to the first input may be the sensing voltage VSIG, and the voltage corresponding to the second input may be the initial reference voltage VINIT.

Referring to operation S200, the voltage of one end of the first sampling capacitor Cs1 may be set to a voltage level corresponding to the second input. According to an embodiment, by setting the voltage at one end of the first sampling capacitor Cs1 to the same voltage level as the initial reference voltage VINIT, the voltage across both ends of the first sampling capacitor Cs1 may be limited to a certain range.

Referring to operation S300, level-shifting may be performed to the second reference voltage Vref2 while maintaining the voltage difference between both ends of the first sampling capacitor Cs1. According to an embodiment, the second reference voltage Vref2 may be a lower voltage than the initial reference voltage. This operation may be done by setting the voltage of one end of the first sampling capacitor Cs1 to the voltage level corresponding to the second reference voltage Vref2. In this way, when transmitting voltage from a high voltage region to a low-voltage region, more stable voltage transmission is possible and offset may be minimized by reducing the voltage while maintaining the voltage at both ends thereof through the level-shifting.

Referring to operation S400, the voltage difference between the first sampling capacitor Cs1 and the second sampling capacitor Cs2 may be transmitted to the amplifying circuit 2000a. By these operations, compensation of the sensing voltage may be possible while maintaining the operating voltage of the first sampling capacitor Cs1 small so that an area-efficient sensing circuit may be implemented.

The present embodiment may be applicable to a sensing system that performs voltage scaling with a low-voltage ADC using a sampling capacitor receiving a high-voltage input.

According to an aspect of the disclosure, the sample and hold circuit further comprises a reset circuit configured to reset voltages at the first end and a second end of the first sampling capacitor and the first end and a second end of the second sampling capacitor, and wherein the reset circuit comprises: a first reset switch connected in parallel with the first sampling capacitor, and a second reset switch connected in parallel with the second sampling capacitor.

According to an aspect of the disclosure, the sample and hold circuit comprises a high-voltage region in which high-voltage switching elements are provided, and a low-voltage region in which low-voltage switching elements are provided, and wherein the first voltage switch circuit and the reset circuit are provided in the high-voltage region.

According to an aspect of the disclosure, an operating method of a sensing circuit, the operating method comprising: turning on a plurality of first switches to sample a first voltage corresponding to a first input to a first sampling capacitor and sample a second voltage corresponding to a second input to a second sampling capacitor; turning off the plurality of first switches and turning on a plurality of second switches to shift voltage levels of the first sampling capacitor and the second sampling capacitor; and turning off the plurality of second switches and turning on a plurality of third switches to transmit, to an amplifying circuit, a voltage difference between voltages stored in the first sampling capacitor and the second sampling capacitor, wherein the plurality of first switches comprises a first voltage-setting switch and a second voltage-setting switch configured to set the voltage applied to one end of the first sampling capacitor and one end of the second sampling capacitor to a first level, wherein the first level corresponds to an initial reference voltage signal, and wherein the plurality of second switches comprises a third voltage-setting switch and a fourth voltage-setting switch respectively configured to set one end of the first sampling capacitor and one end of the second sampling capacitor to a second level lower than the first level.

While certain embodiments of the disclosure have been particularly shown and described, it will be understood that various changes in form and details may be made therein without departing from the spirit and scope of the following claims.

What is claimed is:

1. A sensing circuit comprising:
a sample and hold circuit configured to sample and hold a voltage difference between a first input and a second input, based on a sensing voltage being the first input and an initial reference voltage being the second input; and
an amplifying circuit configured to amplify and output an output of the sample and hold circuit,
wherein the sample and hold circuit comprises:
a first sampling capacitor configured to sample a voltage level of the sensing voltage;
a second sampling capacitor configured to sample the voltage level of the initial reference voltage; and
a first voltage switch circuit configured to set a voltage applied to a first end of the first sampling capacitor and a first end of the second sampling capacitor to a first level, wherein the first level is the voltage level of the initial reference voltage.

2. The sensing circuit of claim 1, wherein the first voltage switch circuit is connected between the first end of the first sampling capacitor and the first end of the second sampling capacitor.

3. The sensing circuit of claim 2, wherein the first voltage switch circuit comprises a first voltage-setting switch and a second voltage-setting switch,
wherein a first end of the first voltage-setting switch is connected to the first end of the first sampling capacitor,
wherein a first end of the second voltage-setting switch is connected to the first end of the second sampling capacitor, and
wherein a second end of the first voltage-setting switch and a second end of the second voltage-setting switch are configured to connect to a terminal applying the voltage level of the initial reference voltage.

4. The sensing circuit of claim 3, wherein the sample and hold circuit comprises:
a high-voltage region in which high-voltage switching elements are provided; and
a low-voltage region in which low-voltage switching elements are provided, and
wherein the first voltage switch circuit comprises the high-voltage switching elements.

5. The sensing circuit of claim 4, wherein the sample and hold circuit comprises a second voltage switch circuit configured to level-shift a capacitor voltage applied to the first end of the first sampling capacitor and the first end of the second sampling capacitor to a second level, and
wherein the second voltage switch circuit comprises the low-voltage switching elements.

6. The sensing circuit of claim 5, wherein the sample and hold circuit further comprises:
a first bias transistor connected between a first end of the first voltage switch circuit and a first end of the second voltage switch circuit; and
a second bias transistor connected between a second end of the first voltage switch circuit and a second end of the second voltage switch circuit, and
wherein the first bias transistor and the second bias transistor are disposed in the high-voltage region.

7. The sensing circuit of claim 1, wherein the sample and hold circuit further comprises a reset circuit configured to reset voltages at the first end and a second end of the first sampling capacitor and the first end and a second end of the second sampling capacitor.

8. The sensing circuit of claim 7, wherein the reset circuit comprises:
a first reset switch connected in parallel with the first sampling capacitor; and
a second reset switch connected in parallel with the second sampling capacitor.

9. The sensing circuit of claim 8, wherein each of the first reset switch and the second reset switch is configured to be turned on by a reset signal,
wherein switches included in the first voltage switch circuit are configured to be turned on by a first voltage-setting signal, and
wherein a first period where the reset signal is turned on and a second period where the first voltage-setting signal is turned on at least partially overlap in a time period.

10. The sensing circuit of claim 9, wherein a starting time point of the first period is set earlier than a starting time point of the second period.

11. A sensing circuit configured to sense information received from a display panel and generate sensing data corresponding thereto, the sensing circuit comprising:
a sample and hold circuit comprising a sampling capacitor, the sample and hold circuit being configured to:
generate a first voltage difference between a sensing voltage and an initial reference voltage by sampling the sensing voltage and the initial reference voltage, and
maintain the first voltage difference as a constant; and
an amplifying circuit configured to amplify the first voltage difference to generate an output voltage,
wherein the sampling capacitor comprises:
a first sampling capacitor configured to sample the sensing voltage; and
a second sampling capacitor configured to sample the initial reference voltage, and
wherein a range of an operating voltage of the first sampling capacitor is equal to or less than a second voltage difference between a first voltage level corresponding to the sensing voltage and a second voltage level corresponding to the initial reference voltage.

12. The sensing circuit of claim 11, wherein the sample and hold circuit comprises a first voltage switch circuit configured to set a lower reference of the range of the operating voltage of the first sampling capacitor.

13. The sensing circuit of claim 12, wherein the first voltage switch circuit is configured to set the lower reference to the initial reference voltage.

14. The sensing circuit of claim 12, wherein the sample and hold circuit comprises a second voltage switch circuit configured to level-shift a voltage applied to one end of the first sampling capacitor and one end of the second sampling capacitor while maintaining the range of the operating voltage of the first sampling capacitor.

15. The sensing circuit of claim 14, wherein the first voltage switch circuit comprises a first voltage-setting switch and a second voltage-setting switch that are configured to set one end of the first sampling capacitor and one end of the second sampling capacitor to a first level upon turn-on of a first voltage-setting signal,
wherein the second voltage switch circuit comprises a third voltage-setting switch and a fourth voltage-setting switch that are configured to set the one end of the first sampling capacitor and the one end of the second sampling capacitor to a second level lower than the first level upon turn-on of a second voltage-setting signal.

16. The sensing circuit of claim 14, wherein the sample and hold circuit comprises one or more bias transistors configured to control electrical connection between the first voltage switch circuit and the second voltage switch circuit.

17. The sensing circuit of claim 11, wherein the sample and hold circuit comprises a reset circuit configured to reset voltages at first and second ends of the first sampling capacitor and the second sampling capacitor.

18. The sensing circuit of claim 17, wherein the reset circuit comprises a first reset switch and a second reset switch that are configured to reset voltages at the first and second ends of the first sampling capacitor and the second sampling capacitor upon turn-on of a reset signal.

19. A display device comprising:
a display panel comprising a plurality of organic light-emitting diodes (OLEDs) and a plurality of driving thin-film transistors (TFTs) configured to control an amount of light emitted from the OLEDs, wherein a plurality of pixels connected to data lines and sensing lines are arranged on the display panel; and
a data driving circuit comprising:
a plurality of digital-to-analog converters (DACs) configured to apply sensing data voltages to the data lines during a sensing operation,
a plurality of sensing circuits configured to sense current information of the plurality of pixels through a plurality of sensing channels connected to the sensing lines, and
a plurality of analog-to-digital converters (ADCs), each commonly connected to the plurality of sensing circuits,
wherein each sensing circuit of the plurality of sensing circuits comprises:
a sample and hold circuit configured to generate and maintain constant a voltage difference between a first input and a second input, based on a sensing voltage being the first input and an initial reference voltage being the second input, and
an amplifying circuit configured to amplify an output of the sample and hold circuit, and
wherein the sample and hold circuit comprises:
a first sampling capacitor configured to sample a voltage level of the sensing voltage,
a second sampling capacitor configured to sample the voltage level of the initial reference voltage, and
a first voltage switch circuit configured to set a voltage applied to a first end of the first sampling capacitor and a first end of the second sampling capacitor to a first level, wherein the first level is the voltage level of the initial reference voltage.

20. The display device of claim 19, wherein the first voltage switch circuit comprises a first voltage-setting switch and a second voltage-setting switch,
wherein a first end of the first voltage-setting switch is connected to the first end of the first sampling capacitor,
wherein a first end of the second voltage-setting switch is connected to the first end of the second sampling capacitor, and
wherein a second end of the first voltage-setting switch and a second end of the second voltage-setting switch are connected to a terminal applying the voltage level of the initial reference voltage.
